(19) United States
(12) Patent Application Publication
(10) Pub. No.: US 2009/0324849 A1
(43) Pub. Date: Dec. 31, 2009

(54) METHOD FOR SEALING PORES IN A POROUS SUBSTRATE

(75) Inventors: George D. PAPASOULIOTIS, North Andover, MA (US); Vikram Singh, North Andover, MA (US)

Correspondence Address: VARIAN SEMICONDUCTOR EQUIPMENT ASSC., INC., 35 DORY RD., GLOUCESTER, MA, 01930-2297, US

(73) Assignee: VARIAN SEMICONDUCTOR EQUIPEMENT ASSOCIATES, INC., Gloucester, MA (US)

(21) Appl. No.: 12/344,533

(22) Filed: Dec. 28, 2008

Related U.S. Application Data
(60) Provisional application No. 61/017,258, filed on Dec. 28, 2007.

(51) Int. Cl. H05H 1/24; B05D 1/12

(52) U.S. Cl. 427/569; 427/201

(57) ABSTRACT

Several embodiments of a method for sealing pores on a porous substrate are disclosed. In one embodiment, the method comprises introducing first particles to the surface of the substrate and damaging the surface to decrease the size of the pores on the surface; introducing second particle to the surface; and forming a film on the surface covering the pores, where the film has a dielectric constant of 4 or less.

This application claims priority to a Provisional Application No. 61/017,258 titled “METHOD FOR SEALING PORES IN A POROUS FILM” and filed on Dec. 28, 2007, which is incorporated, in its entirety, by reference.

### FIELD

The present disclosure relates to substrate processing, more particularly to a technique for sealing pores in a porous substrate.

### BACKGROUND

A semiconductor device may include circuits that connect and route electrical signals to and from millions of transistors and other electrical elements. As the devices have become more complex, the number of the circuits has increased. To accommodate this increase, multi-level or multi-layered interconnection schemes such as, Damascene interconnect structures has been used. Referring to FIG. 1, a conventional Damascene structure may comprise a dielectric layer 102 having trenches or vias 104 and metal circuits 106 that route the electrical signals.

One disadvantage of the Damascene structure is resistive-capacitive (“RC”) signal delay associated with high resistance of the metal circuit 106 and high capacitance of the dielectric layer. In order to minimize the delay, a porous dielectric 102, having a dielectric constant (“K”) of approximately 2.5 or less, has been used. As copper from the circuit 106 is adjacent to the pores, copper may diffuse into the pores and cause line-to-line leakage or electrical breakdown in the dielectric layer 102. As such, a method of sealing pores of the porous dielectric layer is needed.

### SUMMARY

Several embodiments of a method for sealing pores on a porous substrate are disclosed. In one embodiment, the method comprises introducing first particles to the surface of the substrate and damaging the surface to decrease the size of the pores on the surface; introducing second particle to the surface; and forming a film on the surface covering the pores, where the film has a dielectric constant of 4 or less.

In another embodiment, the first particles may be metastables selected from a group consisting of helium (He), neon (Ne), xenon (Xe), argon (Ar), krypton (Kr), radon (Rn), hydrogen (H₂), oxygen (O₂), carbon monoxide (CO), and carbon dioxide (CO₂).

In another embodiment, the first particles comprise oxidizing agent or reducing agent.

In another embodiment, the first particles comprise ions.

Yet in another embodiment, the second particles saturate at least a portion of the substrate surface.

In another embodiment, the method further comprises introducing third particles to the surface of the substrate; activating the surface of the substrate; and binding the second particles to the surface of the substrate.

In another embodiment, the third particles comprise at least one of metastables and ions.

Yet in another embodiment, the method further comprises providing thermal energy to the substrate surface so as to activate the surface; and binding the second particles to the surface of the substrate.

In another embodiment, the second particles comprise organic particles.

In another embodiment, the organic particles comprise one or more species selected from a group consisting of include siloxane, polysiloxane, octamethylcyclotetrasiloxane (OMCTS), Hexamethyldisiloxane (HMDSO), methylsilane (CH₃SiH), tetramethylcyclotetrasiloxane (TMCTS).

In another embodiment, the film comprises a species selected from a group consisting of organosilicate glass film, SiCOH film, fluorosilicate glass film, and polymer film.

In another embodiment, the method further comprises disposing the porous substrate in a plasma processing system; providing a precursor; providing a dilutant gas; and generating a plasma containing the first particles.

In another embodiment, the precursor contains species selected from a group consisting of carbon, silicon, and nitrogen.

In another embodiment, the dilutant comprises species selected from a group consisting of helium (He), neon (Ne), xenon (Xe), argon (Ar), krypton (Kr), and radon (Rn).

### BRIEF DESCRIPTION OF THE DRAWINGS

In order to facilitate a fuller understanding of the present disclosure, reference is now made to the accompanying drawings. These figures should not be construed as limiting the present disclosure, but are intended to be exemplary only.

FIG. 1 illustrates a Damascene interconnect structure.

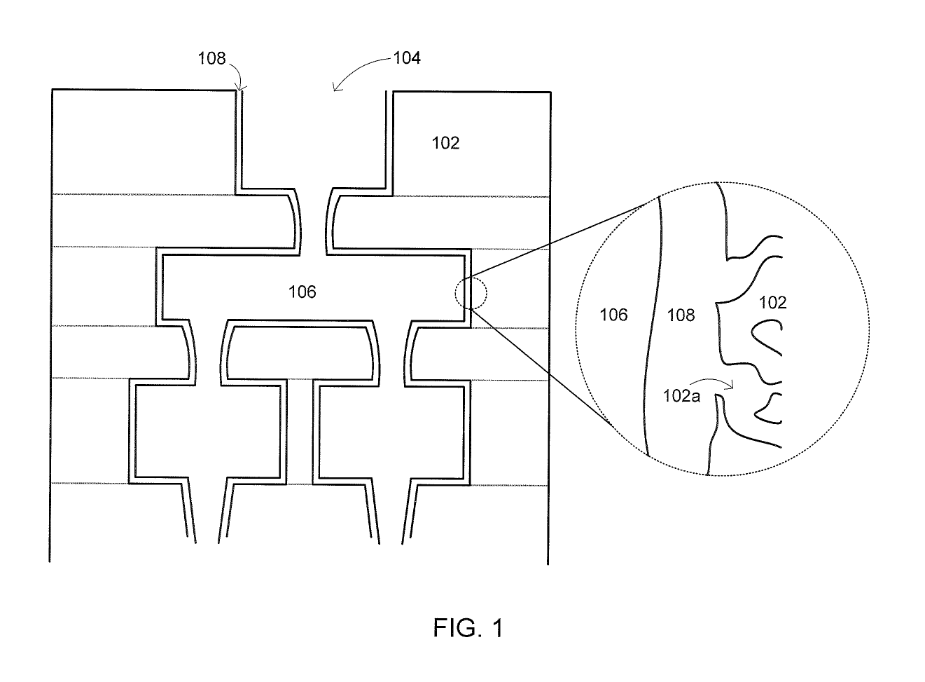

FIG. 2a illustrates a pore sealing technique according to one embodiment of the present disclosure.

FIG. 2b illustrates a detailed diagram of a film formation phase 22 of the pore sealing technique shown in FIG. 2a.

FIG. 3 illustrates a flow chart of a pore sealing technique according to one embodiment of the present disclosure.

FIG. 4 illustrates a flow chart of a pore sealing technique according to another embodiment of the present disclosure.

FIG. 5 illustrates a flow chart of a pore sealing technique according to another embodiment of the present disclosure.

FIG. 6 illustrates a flow chart of a pore sealing technique according to another embodiment of the present disclosure.

FIG. 7 illustrates a flow chart of a pore sealing technique according to another embodiment of the present disclosure.

FIG. 8 illustrates a flow chart of a pore sealing technique according to another embodiment of the present disclosure.

FIG. 9 illustrates a pore sealing system according to one embodiment of the present disclosure.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### DETAILED DESCRIPTION

To solve the aforementioned problems associated with the porous substrate, the present disclosure introduces several embodiments of a pore sealing technique. Although the present disclosure focuses on sealing the pores on a porous dielectric layer of Damascene structure, the disclosure may be equally applicable to other types of porous substrate. The substrate may be dielectric, metallic, or semiconducting material, or a combination thereof.

For purpose of clarity, the following disclosure may be made in context to activation agents (AA) and precursors. Activation agents may be thermal, optical, or kinetic energy or those capable of providing such energy to a target such as, for example, atoms/molecules disposed on the substrate surface to raise free energy or “activate” the target. In some embodiments, activation agents may provide sufficient energy to break at least one bond associated with the target. Examples of activation agents may include charged or neutral, subatomic, atomic, or molecular particles, or optical or thermal quantized energy particles (e.g. photon, phonon, etc. . . . ). Other examples of AA may include chemically reactive atoms/molecules.

The precursors, meanwhile, may be atoms and molecules, and the fragments thereof (i.e. neutrals, ions, radicals etc. . . . ) capable of forming a film having a dielectric constant of less than approximately 4. Examples of the precursor species may include siloxane, polysiloxane, octamethylcyclotetrasiloxane (OMCTS), Hexamethyldisiloxane (HMDSO), methylsilane (CH₃SiH), tetramethylcyclotetrasiloxane (TMCTS), and a combination thereof. Other precursor species having a large diameter and capable of forming a low-k dielectric film (i.e. film with dielectric constant of less than 4) such as, for example, organosilicate glass film, SiCOH film, fluorosilicate glass film, or polymer film, are not precluded as the precursor. Although the precursors may include, in some embodiment, molecule fragments (e.g. neutrals, radicals, or ions), the precursors in the present disclosure may preferably be those in stable state.

For purpose of clarity, the present disclosure focuses on processes analogous to atomic layer deposition (ALD) process and a plasma based deposition process. In addition, the present disclosure focuses on a plasma processing system, an ALD system, or a system capable of performing both techniques. However, those of ordinary skill in the art will recognize that the present disclosure may be equally applicable to other types of processes or systems.

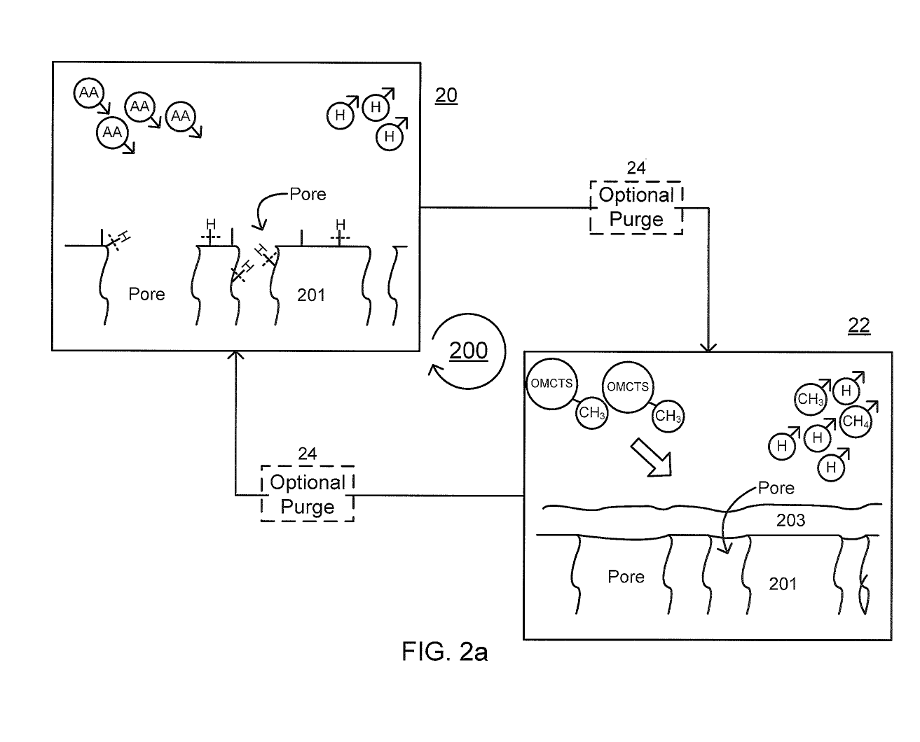

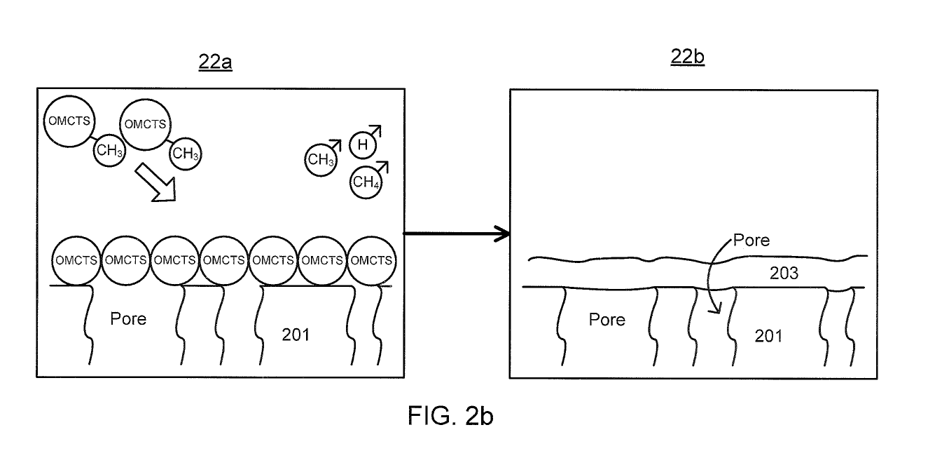

Referring to FIGS. 2a and 2b, there is a pore sealing technique 200 according to one embodiment of the present disclosure. The pore sealing technique may be at least one cycle 200; the cycle 200 may comprise at least one or both of an activation phase 20 and a film formation phase 22. The cycle 200 may optionally comprise a purge step 24 between the activation phase 20 and the film formation phase 22, and a plasma and/or heat treatment phase.

During the activation phase 20, the substrate 201 surface may be activated and break (as shown by the dotted line) the bonds between the atoms/molecules of the surface and excess atoms/molecules adsorbed to the surface. In the present disclosure, the excess atoms/molecules may include those of byproduct, contaminant, passivating layer, and/or ligand adsorbed to the substrate 201 surface. If the substrate 201 has a plurality of excess hydrogen (H) atoms on the surface, the bonds between substrate 201 and H atoms may be broken, and the excess H atoms may be removed from the surface.

The substrate 201 may be a porous dielectric substrate. Examples of the substrate may include amorphous glass substrate, an organosilicate glass substrate, an fluorosilicate glass substrate, polymer substrate, or a combination thereof.

The activation agent, meanwhile, may be metastables capable of emitting photons of sufficient energy and intensity to activate the substrate surface. Examples of the metastables may include helium (He) metastables, argon (Ar) metastables, neon (Ne) metastables, and xenon (Xe) metastables. Additional examples of the metastables may include those generated through decomposition of nitrogen (N₂), oxygen (O₂), carbon monoxide (CO), carbon dioxide (CO₂), and a combination thereof. Those of ordinary skill in the art will also recognize that other types of metastables may also be used. The metastables may be generated in a plasma source such as, for example, an inductively coupled plasma (“ICP”) source, capacitively coupled plasma (“CCP”) source, a microwave (“MW”) source, or a helicon source. The plasma may be generated and positioned near the substrate 201. Alternatively, the plasmas may be generated remotely, from a remote plasma source, and be transported to a position near the substrate.

Other types of AA may include charged or neutral particles, such as, for example, ions, atomic/molecular clusters, or radicals, that are introduced to the substrate with sufficient kinetic energy to activate the substrate surface. Other types of activation agents may include reactive etchants such as wet, dry, plasma, or sputter etchant. Oxidizing or reducing agents may also be used as AA. Particular examples of the oxidizing and reducing agents may include oxygen (O₂), ozone (O₃), water vapor (H₂O), hydrogen (H₂), ammonia (NH₃), carbon monoxide (CO), and methane (CH₄). The activation agents may also be thermal or optical energy particles applied by a heat or light source. Examples of the heat source may include a resistive, radiative, or conductive heat source proximate to the substrate. Meanwhile, the light source may be, for example, a continuous wave (“CW”) laser, an excimer laser, or a dye laser emitting an electromagnetic wave at UV to IR range.

In the present disclosure, the substrate surface 201 may preferably be damaged prior to or during the activation phase 20. If the surface damage is desired, one or more types of AA capable of transporting kinetic energy (e.g. metastables or ions) may be delivered to the substrate with sufficient kinetic energy to damage the substrate surface. In another embodiment, reactive AA may be delivered to damage the substrate surface. Yet in another embodiment, thermal energy or optical energy may be provided to the substrate to cause the surface damage. By damaging the substrate surface, the pores may be sealed, or the size of the pores on the surface may decrease. The process, therefore, may at least aid any subsequent formation of pore sealing film. Although damaging the substrate surface may be preferable, the present disclosure does not preclude an activation stage without damaging the substrate surface.

During the film formation phase 22, a conformal film may form on the substrate surface to seal the pores. Referring to FIG. 2b, a detailed illustration of the phase 22, the film may form via a process analogous to ALD process or a process analogous to a plasma deposition process. In the former process, organic precursors containing organic ligand may saturate at least a portion of the substrate surface such that a monolayer of precursor may be disposed on the substrate. Thereafter, the introduction of the precursors may be discontinued, and precursors that are not part of the monolayer may be removed. The precursors that are part of the monolayer, meanwhile, may be activated, as illustrated in the first sub-phase 22a, and organic ligands may be removed from the precursors. The precursors may then react with the atom/molecules of the substrate surface and with one another, forming a monolayer of pore sealing film. The saturation and the reaction may be repeated to form the pore sealing film one monolayer at a time until a film with desired thickness is formed, as illustrated in the second sub-phase 22b.

In the above embodiment, only one species of precursor may preferably be introduced during each introduction phase 22. If two or more species of precursor are desired, different species may be introduced sequentially, during different introduction phases 22 of different cycles 200. Avoiding simultaneous introduction of different species may enable self-limiting reactions to form a uniform film one monolayer at a time.

The amount of the precursors introduced to the substrate 201 may depend on the surface area of the substrate 201. Meanwhile, the substrate 201, as well as the process environment, may be kept at a carefully selected temperature to prevent the precursors from condensing or decomposing on the substrate surface prior to introduction of AA. In one embodiment, the substrate 201 may be maintained at a temperature equal to or less than 400° C. However, the substrate 201 may be maintained at other temperatures as well.

To remove excess atoms/molecules and/or precursors that are not part of the monolayer, the substrate surface 202 may be purged 24 with one or more inert gas (e.g., helium, neon, or argon) before and/or after each film formation phase 22. The purge step 24, however, may be optional and may be omitted if the cycle 200 does not include the film formation phase 22 or if the film formation phase 22 is that similar to a plasma based deposition process discussed below. If included, the purge step 24 may be facilitated by evacuating the system sealing the pores on the substrate.

In the embodiment analogous to the plasma deposition process, organic precursors containing organic ligands may be introduced to the substrate. The introduced precursors may preferably be large molecules capable of forming a film having a dielectric constant of less than approximately 4. However, the present embodiment does not preclude the precursors being fragments of the molecules (e.g. ions, radicals, and/or neutrals). As illustrated in first sub-phase 22a, the introduced precursors may be activated and the organic ligands may be removed from the precursors. The activated precursors form the pore sealing film by reacting with the atom/molecules of the substrate surface and with one another, as illustrated in the second sub-phase 22b. Unlike the process analogous to ALD process, sequential saturation and reaction, to form one monolayer of the precursor or the film at a time, need not be performed. Instead, the precursor may be introduced and react with the substrate surface continually. In addition, simultaneous introduction of two or more different species of the precursor is not precluded if desired. Further, introducing the precursor at sufficiently high kinetic energy to simultaneously induce surface damage is also not precluded.

In both embodiments, the reactions between the precursors and the atoms/molecules, and between the precursors, may be induced by AA. The activation agents may be introduced to the substrate during or after the precursors are introduced. The activation agents may be heat energy provided by a heat source (not shown). The heat source such as, for example, a platen or a resistive heat source may be positioned near the substrate 201 to provide the thermal energy to the precursors directly or via the substrate. Alternatively, metastables, charged or neutral particles, radicals, oxidizing or reducing agents, etchant, and/or optical energy may be AA inducing the reaction between the precursors and between the precursors and the atoms/molecules near the substrate surface.

The pore sealing technique of the present disclosure may optionally comprise a plasma and/or heat treatment performed after film is formed. The treatment may be performed to enhance adhesiveness, density, and/or mechanical strength of the formed film. The treatment may be performed in a system where the substrate is processed or, alternatively, in a different system. If the treatment is performed in the same system, the treatment may be performed by modifying the type and/or flow of the gas or plasma introduced to the substrate 201.

The pore sealing technique of the present disclosure may comprise one or more cycles 200 having various combination of the activation phase 20 and/or the film formation phase 22. If both the activation phase 20 and the film formation phase 22 are included, the order of the phases 20 and 22 is not limited to a particular order. By controlling the cycles 200, the phases 20 and 22, the environment during which one or more phases 20 and 22 take place (e.g. temperature and/or pressure), and the types and the flux of the precursors and the activation agents, the pores may be sealed.

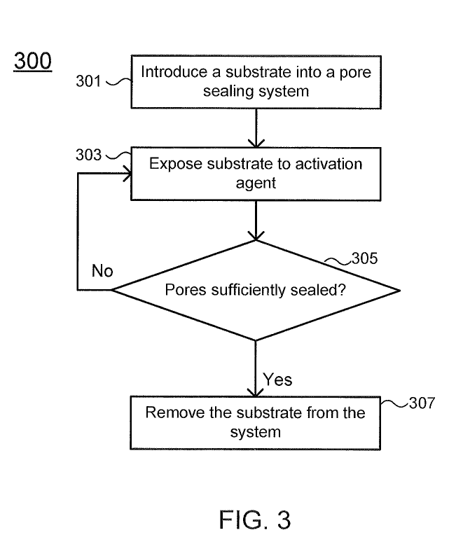

Referring to FIG. 3, there is shown a flow chart of an exemplary pore sealing technique according to one embodiment of the present disclosure. In step 301, a porous substrate may be introduced to a pore sealing system. Thereafter, in step 303, the substrate may be exposed to AA capable of inducing sufficient surface damage to close the pores on the substrate.

In step 305, it may be determined whether the pores on the substrate are sufficiently closed. If the pores on the substrate are sufficiently closed, the substrate may be removed, in step 307, from the system. Otherwise, the process may return to step 303, and steps 303 and 305 may be repeated until the pores are sufficiently closed. After it is determined that the pores on the substrate are sufficiently sealed, the optional plasma and/or heat treatment may be performed to enhance the substrate properties.

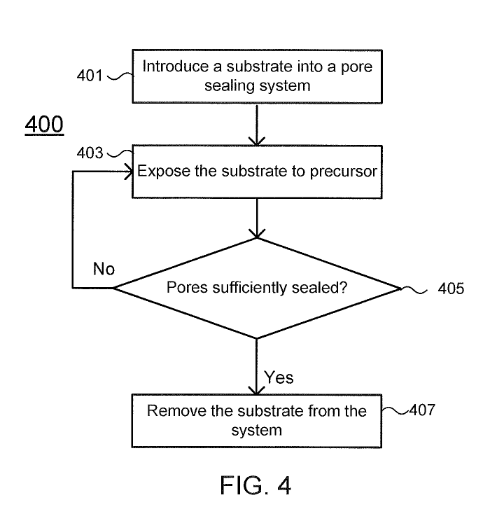

Referring to FIG. 4, there is shown a flow chart of an exemplary pore sealing technique according to another embodiment of the present disclosure. In step 401, a porous substrate may be introduced to a pore sealing system. Thereafter, in step 403, the substrate may be exposed to the precursor. In the present embodiment, the precursors with sufficient kinetic energy may be introduced to saturate the substrate to induce surface damage and to form a film covering the pores simultaneously.

In step 405, it may be determined whether the pores on the substrate are sufficiently closed. If the pores on the substrate are sufficiently closed, the substrate may be removed, in step 407, from the system. Otherwise, the process may return to step 403, and the steps 403 and 405 may be repeated until the pores are sufficiently closed. After it is determined that the pores on the substrate are sufficiently closed, the optional plasma and/or heat treatment may be performed to enhance the film's property.

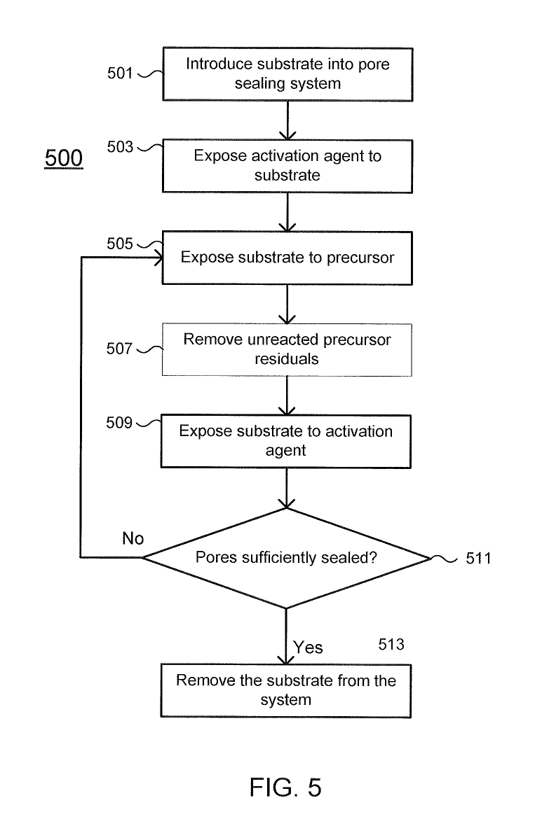

Referring to FIG. 5, there is shown a flow chart of an exemplary pore sealing technique according to another embodiment of the present disclosure. In step 501, a porous substrate may be introduced to a pore sealing system. Thereafter, in step 503, AA may be introduced to the substrate surface to clean or activate the surface. In one embodiment, AA may be capable of inducing sufficient surface damage to close the pores on the substrate.

In step 505, the precursors may be introduced to saturate the substrate surface and form a monolayer of the precursors. In step 507, the system may be pumped down to remove precursors that are not part of the monolayer. In step 509, AA may be introduced to the substrate surface, and a monolayer of a uniform film covering the pores may be formed. The activation agent to form the film may preferably be metastables. However, other types of AA may also be used.

In step 511, it may be determined whether the pores are sufficiently sealed or whether a film having sufficient thickness, density, and/or strength has formed. If the properties of the substrate and the films are determined to be satisfactory, the pore sealing process may proceed to step 513. Otherwise, the process may return to step 505, and steps 505, 507, 509, and 511 may be repeated. After it is determined that properties of the substrate and/or the film is satisfactory, the optional plasma and/or heat treatment may be performed to enhance the film and the substrate properties.

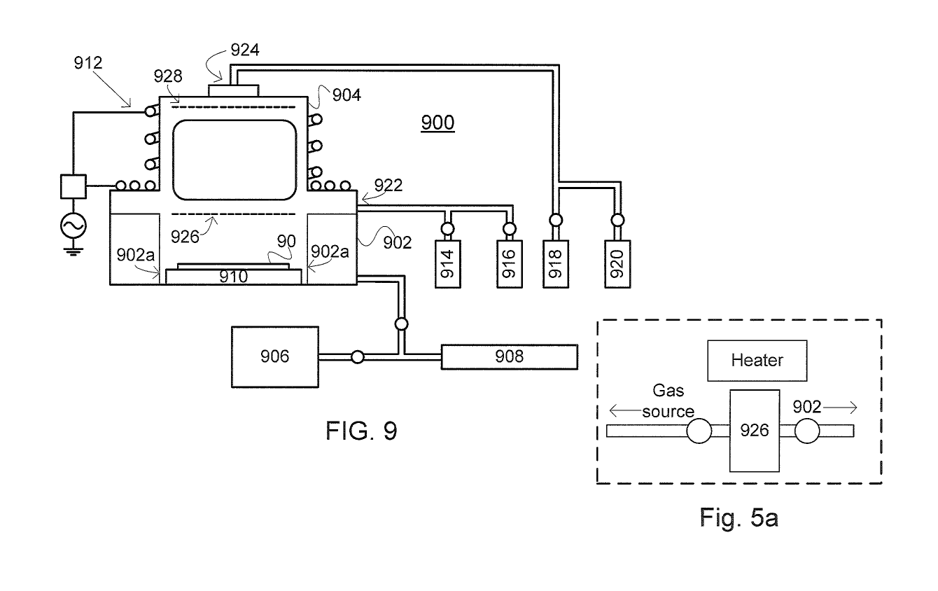

Referring to FIG. 6, there is shown a flow chart of an exemplary pore sealing technique according to another embodiment of the present disclosure. In step 601, a porous substrate may be introduced to a pore sealing system. Thereafter, in step 603, AA may be introduced to the substrate surface to clean or activate the surface. In one embodiment, the AA introduced in step 603 may be those capable of inducing sufficient surface damage to close the pores on the substrate.

In step 605, the properties of the seal may be evaluated. For example, it may be determined whether the pores are sufficiently sealed. If the pores are sufficiently sealed, the pore sealing process may proceed to step 615. Otherwise, the process may proceed to step 607.

In step 607, the precursors may be introduced and may saturate the substrate surface to form a monolayer of the precursors. In step 609, the system may be pumped down to remove any precursor residuals that are not part of the monolayer. In step 611, AA may be introduced to the substrate surface, and a monolayer of uniform film covering the pores may be formed. Although AA introduced to form the film may preferably be metastables, other types of AA may also be used.

In step 613, the properties of the formed film may be evaluated. For example, it may be determined whether the pores are sufficiently sealed. It may also be determined whether the film has sufficient thickness, density, and/or strength. If the properties of the substrate and the films are determined to be satisfactory, the pore sealing process may proceed to step 615. Otherwise, the process may return to step 605, and steps 605, 607, 609, and 611 may be repeated. After it is determined that the pores on the substrate are sufficiently closed, the optional plasma and/or heat treatment may be performed to enhance the substrate properties.

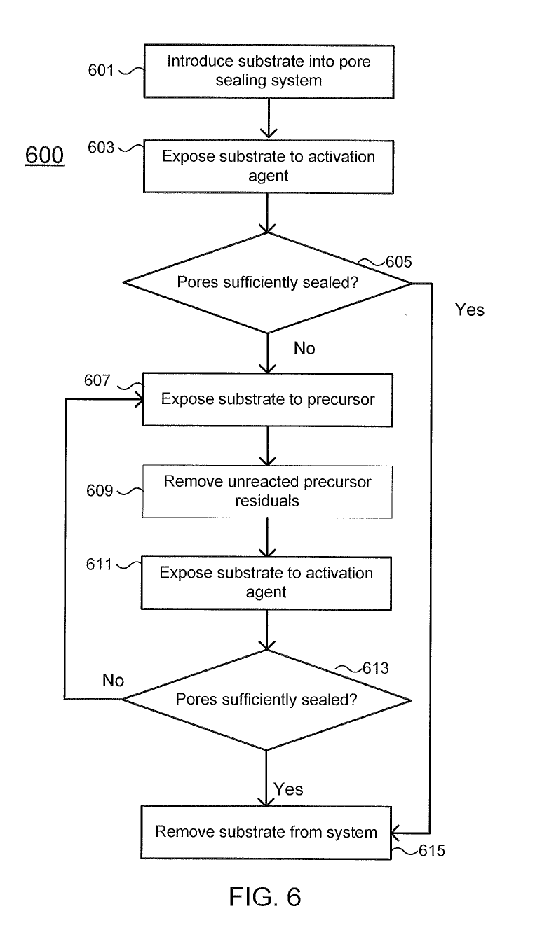

Referring to FIG. 7, there is shown a flow chart of an exemplary pore sealing technique according to another embodiment of the present disclosure. In step 701, a porous substrate may be introduced to a pore sealing system. Thereafter, in step 703, AA may be introduced to the substrate surface to clean or activate the surface. In one embodiment, AA introduced in step 703 may be those capable of inducing sufficient surface damage to close the pores on the substrate.

In step 705, the properties of the substrate may be evaluated. For example, it may be determined whether the pores on the substrate are sufficiently closed. If the pores are sufficiently closed, the pore sealing process may proceed to step 711. Otherwise, the process may proceed to step 707. In step 707, at least one species of precursor may be introduced. If more than one species is introduced, the precursors may be introduced simultaneously. In addition, the precursors may be introduced at energy sufficient to induce additional substrate surface damage. In step 709, AA may be introduced to the substrate surface to induce the precursors to react with one another and with atoms/molecules of the substrate surface to form a film covering the pores. Although AA introduced to form the film may preferably be metastables, other types of AA may also be used.

In step 711, the film or substrate may be evaluated. For example, it may be determined whether the pores on the substrate may be sufficiently minimized. In addition, it may be determined whether a film of sufficient density and/or thickness has formed. If the properties of the film and the substrate are determined to be satisfactory, the process may proceed to step 713. Otherwise, the process may return to step 707, and steps 707, 709, and 711 may be repeated. After it is determined that the pores on the substrate are sufficiently sealed, the optional plasma and/or heat treatment may be performed to enhance the substrate and the film properties.

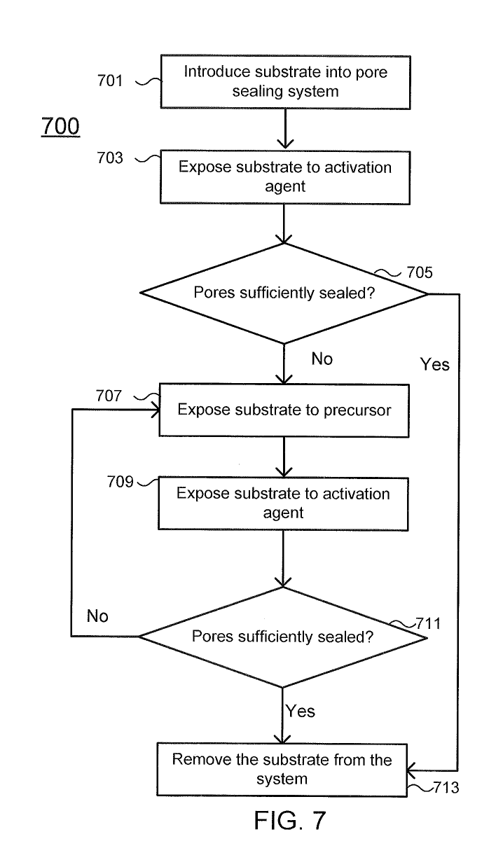

Referring to FIG. 8, there is shown a flow chart of an exemplary pore sealing technique according to another embodiment of the present disclosure. In step 801, a porous substrate may be introduced to a pore sealing system. Thereafter, in step 803, AA may be introduced to the substrate surface to clean or activate the surface. In one embodiment, AA introduced in step 803 may be those capable of inducing sufficient surface damage to close the pores on the substrate.

In step 805, a first seal-bearing precursor species may be introduced to saturate at least a portion of the substrate surface and to form a monolayer of first seal-bearing precursor species. In step 807, the system may be pumped down and any precursor residuals not part of the monolayer may be removed from the system. In step 809, the substrate may be activated with AA.

In step 811, the substrate may be exposed to a second seal-bearing precursor species. In the present embodiment, the second precursor species may be different from the first precursor species. Thereafter, in step 813, the substrate may be activated with AA.

In step 815, it may be determined whether the pores are sufficiently sealed and/or whether the seal having a sufficient thickness is formed. If film having sufficient thickness is formed, the pore sealing process may proceed to step 817. Otherwise, the process may return to step 805, and steps 805, 807, 809, 811, 813, and 815 may be repeated. After the film or seal of desired qualities are formed, the resulting film may undergo an optional heat/plasma treatment process to further improve the quality of the film and the substrate.

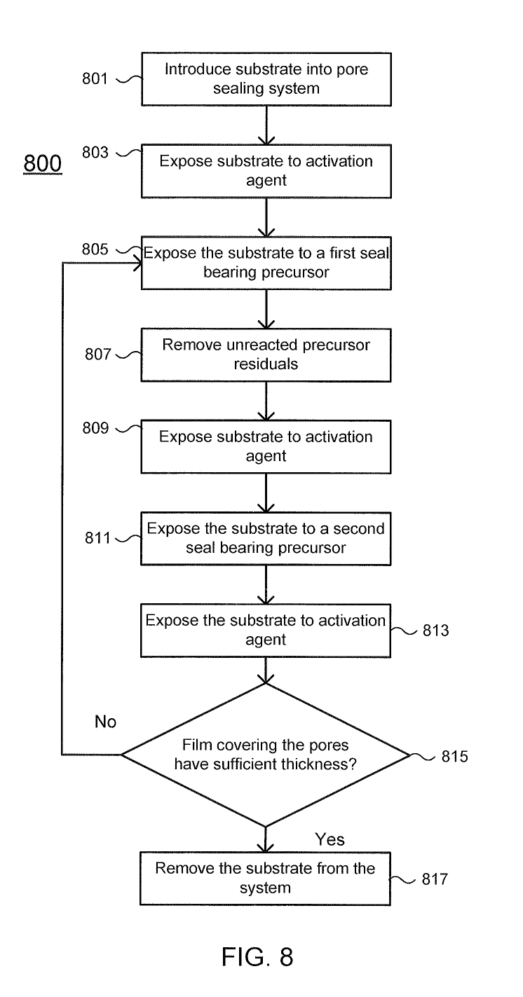

Referring to FIG. 9, there is shown a system for sealing pores on a porous substrate in accordance with an embodiment of the present disclosure. The system 900 may comprise a process chamber 902, which is typically capable of a high vacuum base pressure (e.g., 10⁻⁷-10⁻⁶ torr) with, for example, a turbo pump 906, a mechanical pump 908, and other necessary vacuum sealing components. Inside the process chamber 902, there may be a platen 910 that supports at least one substrate 90. The platen 910 may be equipped with one or more temperature management devices to adjust and maintain the temperature of the substrate 90. Tilting or rotation of the substrate 910 may also be accommodated. A bias source (not shown) may be electrically coupled to the platen 910, thus the substrate 90, to apply a bias voltage to the substrate 90. The process chamber 902 may also be equipped with one or more film growth monitoring devices, such as a quartz crystal microbalance and/or a RHEED (reflection high energy electron diffraction) instrument.

In the present embodiment, the wall of the process chamber 902 may comprise material that prevents precursors from adsorbing to the chamber wall. For example, if organic precursors are introduced to the system 900, the wall of the process chamber 902 may comprise an inorganic material to prevent the adsorption of the organic precursors. In addition, a structure 902a may be provided to minimize the volume of the chamber 902. Decrease in the volume may minimize the amount of necessary precursors and minimize the time necessary to evacuate the process chamber 902.

The system 900 may also comprise a plasma chamber 904 which may be either coupled or spaced apart, hence remote, from the process chamber 902. The plasma chamber may also include a plasma source 912 such as, for example, ICP source, CCP source, MW source, or helicon source. If the plasma chamber 904 is equipped with the ICP source, the system 900 may comprise at least one of planar and helical coils 912a and 912b, an RF power source 912c electrically coupled to at least one of the planar and helical coils 912a and 912b, and an impedance matching network 912d.

The system 900 may further comprise a number of gas supplies. For example, the system 900 may comprise one or more precursor gas supplies 914 and 916, an optional purge gas supply 918, and an activating agent supply 920. The gas may alternatively be metered into the system 900 by a series connection of, for example, a first valve 928, a small chamber 926 of fixed volume, and a second valve 930. The small chamber 926 is first filled to the desired pressure by opening the first valve. After the first valve is closed, the fixed volume of gas is released into the process chamber 902 by opening the second valve 930. Optionally, a heater may be provided near the small chamber 926 to heat the gas contained therein. It should be noted that the above description may also be applied to the inert gas introduced to the plasma chamber 904.

The precursor supplies 914 and 916 may be coupled to the process chamber 902 through a first inlet 922 to supply the precursor to the substrate 90. The purge gas supply 918 and the activation agent supply 920 may be coupled to the plasma chamber 904 through a second inlet 924. The purge gas supply 918 may provide argon (or other inert gases) to purge the system 900. The activation agent supply 920 may supply, for example, helium for plasma generation of helium metastables.

Optionally, the system 900 may comprise a first and second screen or baffle devices 926 and 928. The first screen or baffle device 926 may be disposed between the plasma and the substrate 90. Meanwhile, the second screen or baffle device 928 may be disposed in the plasma chamber 904. The first screen or baffle device 926, either biased or unbiased, may serve to prevent at least a portion of charged particles generated in the plasma chamber 904 from reaching the substrate 90. If biased, the screen or baffle device 926 may be biased with pulsed or continuous DC or RF current. Meanwhile, the second screen or baffle device 928, cooled and grounded, may at least prevent a portion of charged particles generated in the plasma chamber 904 from exiting the plasma chamber 902.

A system and a method for sealing pores on a porous substrate are provided. Although the present disclosure has been described herein in the context of particular embodiments having particular implementation in a particular environment for a particular purpose, those of ordinary skill in the art will recognize that its usefulness is not limited thereto and that the present disclosure may be beneficially implemented in any number of environments for any number of purposes. Various changes in form and detail may be made without departing from the spirit and scope of the invention as defined herein. Accordingly, the claims set forth below should be construed in view of the full breadth and spirit of the present disclosure as described herein.

What is claimed is:

1. A method for sealing pores on a surface of a porous substrate, the method comprising:
introducing first particles to the surface, the first particles inducing damage to the substrate surface so as to decrease a size of the pores disposed on the surface;
introducing second particles to the surface; and
forming a film on the surface covering the pores, the film having a dielectric constant of 4 or less.

2. The method according to claim 1, wherein the first particles comprise metastables, the metastables comprising one or more species selected from a group consisting of helium (He), neon (Ne), xenon (Xe), argon (Ar), krypton (Kr), radon (Rn), hydrogen (H₂), oxygen (O₂), carbon monoxide (CO), and carbon dioxide (CO₂).

3. The method according to claim 1, wherein the first particles comprise oxidizing agent or reducing agent.

4. The method of claim 1, wherein the first particles comprise ions.

5. The method according to claim 1, wherein the second particles saturate at least a portion of the substrate surface.

6. The method of claim 5, further comprising:
introducing third particles proximate to the surface of the substrate;
activating the surface of the substrate; and
binding the second particles to the surface of the substrate.

7. The method of claim 6, wherein the third particles comprise at least one of metastables and ions.

8. The method according to claim 5, further comprising:
providing thermal energy to the substrate surface so as to activate the surface; and
binding the second particles to the surface of the substrate.

9. The method according to claim 1, wherein the second particles comprise organic particles.

10. The method according to claim 9, wherein the organic particles comprise one or more species selected from a group consisting of include siloxane, polysiloxane, octamethylcyclotetrasiloxane (OMCTS), Hexamethyldisiloxane (HMDSO), methylsilane (CH₃SiH), tetramethylcyclotetrasiloxane (TMCTS).

11. The method according to claim 1, wherein the film comprises a species selected from a group consisting of organosilicate glass film, SiCOH film, fluorosilicate glass film, and polymer film.

12. The method according to claim 1, further comprising:
disposing the porous substrate in a plasma processing system;
providing a precursor;
providing a dilutant gas; and
generating a plasma containing the first particles;

13. The method according to claim 12, wherein the precursor contains species selected from a group consisting of carbon, silicon, and nitrogen.

14. The method according to claim 13, wherein the dilutant comprises species selected from a group consisting of helium (He), neon (Ne), xenon (Xe), argon (Ar), krypton (Kr), and radon (Rn).

15. The method according to claim 1, wherein the second particles are continuously introduced to the substrate.

16. The method for sealing pores on a surface of a porous substrate, the method comprising:
disposing a porous substrate in a plasma processing system;
inducing damage on the surface of the porous substrate so as to decrease a size of the pores on the surface;
exposing the surface to first particles;
binding the first particles on the porous substrate; and
forming a film on the surface and sealing the pores.

17. The method according to claim 16, wherein the inducing damage on the surface comprises exposing the substrate to second particles.

18. The method according to claim 17, further comprising generating plasma containing the second particles.

19. The method according to claim 17, wherein the second particles comprises particles selected from a group consisting of ions and metastables.

20. The method according to claim 15, wherein the first particles comprise organic particles selected from a group consisting of siloxane, polysiloxane, octamethylcyclotetrasiloxane (OMCTS), Hexamethyldisiloxane (HMDSO), methylsilane (CH₃SiH), tetramethylcyclotetrasiloxane (TMCTS).
